(19) United States
(12) Patent Application Publication
(10) Pub. No.: US 2024/0397530 A1
(43) Pub. Date: Nov. 28, 2024

(54) ASSISTANCE FRAMEWORK FOR COORDINATION IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US)

(21) Appl. No.: 18/660,146

(22) Filed: May 9, 2024

Related U.S. Application Data
(60) Provisional application No. 63/468,408, filed on May 23, 2023.

(51) Int. Cl. H04W 72/27; H04W 72/0446; H04W 72/0453; H04W 72/30; H04W 72/51

(52) U.S. Cl. CPC H04W 72/27; H04W 72/0446; H04W 72/0453; H04W 72/30; H04W 72/51

(57) ABSTRACT

A wireless communication network includes a first access point (AP) in a wireless network, the first AP comprising: a memory; a processor coupled to the memory, the processor configured to: transmit a request frame to a second AP to set up an assistance link that is used for multi-AP (MAP) coordination; receive a response frame from the second AP where the response frame indicates that the second AP agrees to assist the first AP with MAP coordination, set up an assistance link with the second AP, communicate with the second AP via the assistance link for MAP coordination.

### CROSS-REFERENCE TO RELATED APPLICATIONS

This application claims the benefit of priority from U.S. Provisional Application No. 63/468,408, entitled “Assistance Framework for Coordination in Next Generation Wi-Fi Networks” filed May 23, 2023, which is incorporated herein by reference in its entirety.

### TECHNICAL FIELD

This disclosure relates generally to a wireless communication system, and more particularly to, for example, but not limited to, coordination using assistance links in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first access point (AP) in a wireless network. The first AP comprises a memory and a processor coupled to the memory. The processor is configured to transmit a request frame to a second AP to set up an assistance link that is used for multi-AP (MAP) coordination. The processor is configured to receive a response frame from the second AP, wherein the response frame indicates that the second AP agrees to assist the first AP with MAP coordination. The processor is configured to set up the assistance link with the second AP. The processor is configured to communicate with the second AP via the assistance link for MAP coordination.

In some embodiments, the request frame and the response frame are broadcast frames.

In some embodiments, the processor is further configured to receive an advertisement

from a third AP that advertises a list of assistor APs that are capable of providing coordination for time and frequency resources.

In some embodiments, the processor is further configured to transmit a frame advertising a capability to act as an assistor that is capable of providing coordination for time and frequency resources.

In some embodiments, the processor is further configured to communicate with a third AP to request that the third AP act as a relay node for communications between the first AP and a fourth AP.

In some embodiments, the processor is further configured to transmit a request frame to the third AP to request that the third AP acts as the relay node, and receive a response frame from the third AP to indicate that the third AP agrees to serve as the relay node.

In some embodiments, the third AP is a multi-AP controller that manages the first AP, the second AP and the fourth AP.

In some embodiments, the processor is further configured to communicate a data element on the assistance link from the first AP to the second AP, wherein the data element includes information related to MAP coordination.

In some embodiments, the data element comprises a tracking field that includes address information to track communication amongst the first AP, the second AP and a one or more relay nodes between the first AP and the second AP.

In some embodiments, the tracking field includes one or more address information, each address information being associated with a respective one of the one or more relay nodes.

One aspect of the present disclosure provides a station (STA) in a wireless network. The STA comprises a memory and a processor coupled to the memory. The processor is configured to transmit a request frame to an access point (AP) to set up an assistance link that is used for multi-AP (MAP) coordination. The processor is configured to receive a response frame from the AP, wherein the response frame indicates that the AP agrees to assist the STA with MAP coordination. The processor is configured to set up the assistance link with the AP. The processor is configured to communicate with the AP on the assistance link for MAP coordination.

In some embodiments, the request frame and the response frame are broadcast frames.

In some embodiments, the processor is further configured to receive an advertisement from another AP that advertises a list of assistor APs that are capable of providing coordination for time and frequency resources.

In some embodiments, the processor is further configured to transmit a frame advertising a capability to act as an assistor that is capable of providing coordination for time and frequency resources.

In some embodiments, the AP is a first AP, wherein the processor is further configured to communicate with a second AP to request that the second AP act as a relay node for communications between the STA and a third AP.

In some embodiments, the processor is further configured to transmit a request frame to the second AP to request that the second AP acts as the relay node, and receive a response frame from the second AP to indicate that the second AP agrees to serve as the relay node.

In some embodiments, the second AP is a multi-AP controller that manages the first AP and the third AP.

In some embodiments, the processor is further configured to communicate a data element on the assistance link from the STA to the AP, wherein the data element includes information related to MAP coordination.

In some embodiments, the data element comprises a tracking field that includes address information to track communication amongst the STA, the AP and one or more relay nodes between the STA and the AP.

In some embodiments, the tracking field includes one or more address information, each address information being associated with a respective one of the one or more relay nodes.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example multi-AP configuration illustrating interference issues between different networks.

FIG. 5 illustrates a request frame format in accordance with an embodiment.

FIG. 6 illustrates a response format in accordance with an embodiment.

FIG. 7 illustrates a beacon-based request response procedure in accordance with an embodiment.

FIG. 8 illustrates a request and response frame-based procedure in accordance with an embodiment.

FIG. 9 illustrates a relay request format that can be transmitted to request a node to serve as a relay in accordance with an embodiment.

FIG. 10 illustrates a response element that can be transmitted to the requestor in accordance with an embodiment.

FIG. 11 illustrates a relay set up when an assistance link is already set up in accordance with an embodiment.

FIG. 12 illustrates a relay setup when an assistance link is not set up in accordance with an embodiment.

FIG. 13 illustrates a format for multi-AP information container (MIC) data element (MDE) in accordance with an embodiment.

FIG. 14 illustrates a format of a multi-AP information container (MIC) descriptor element in accordance with an embodiment.

FIG. 15 illustrates a format for MIC of type request in accordance with an embodiment.

FIG. 16 illustrates a path tracking field in accordance with an embodiment.

FIG. 17 illustrates a MIC that includes various reports that a requestor may want to provide to an assistor in accordance with an embodiment.

FIG. 18 illustrates a format of the MIC with interference report in accordance with an embodiment.

FIG. 19 illustrates a format of MIC with QoS characteristics element in accordance with an embodiment.

FIG. 20 illustrates a format of MIC with BSR in accordance with an embodiment.

FIG. 21 illustrates a format of MIC with delay status report in accordance with an embodiment.

FIG. 22 illustrates a format of MIC with TWT schedule info in accordance with an embodiment.

FIG. 23 illustrates a format of MIC generated by the assistor in accordance with an embodiment.

FIG. 24 illustrates a timeline for transmission of MIC with information by requestor and receiving MIC including response from assistor in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

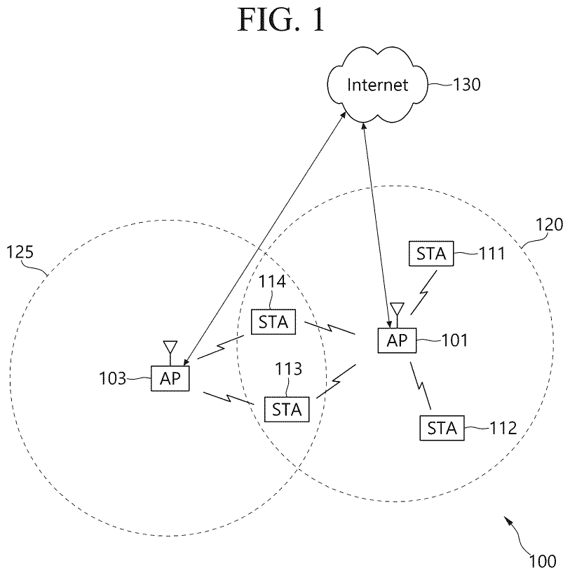

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

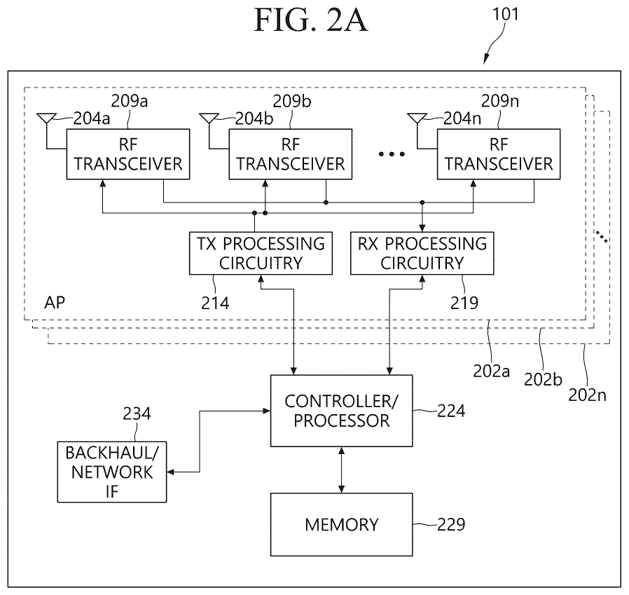

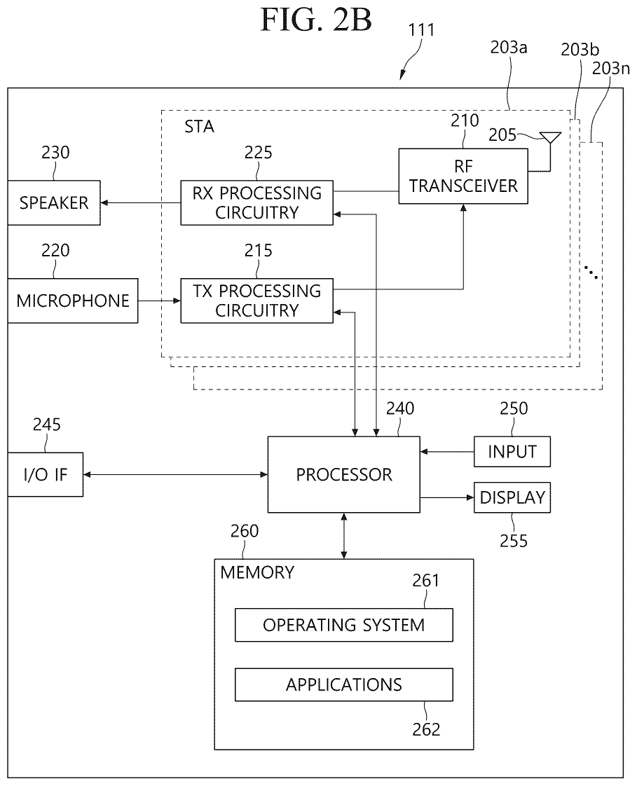

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

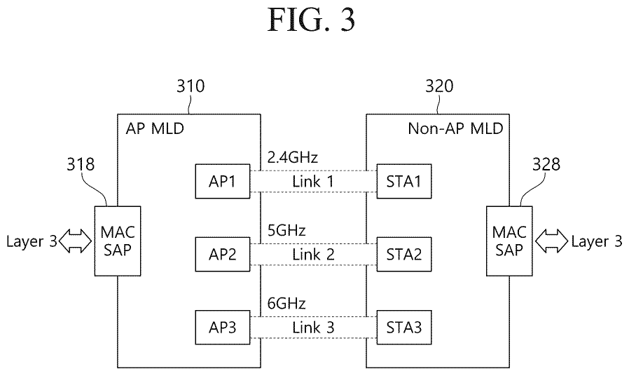

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP1, AP2, and AP3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP1 and the STA 1 may set up Link 1 which operates in 2.4 GHz band. Similarly, the AP2 and the STA 2 may set up Link 2 which operates in 5 GHz band, and the AP3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

There has been an increasing demand for wireless network connectivity in indoor environments. To help address these increased demands, network managers have typically been increasing the number of APs being deployed within the indoor environment. These types of configurations can provide a multi-AP (MAP) network configuration as multiple APs can be utilized to service the traffic demands of the STAs within the network. However, these multi-AP configurations can experience certain performance issues, including issues related to signal interference between APs and STAs, among others. In particular, co-deployed APs in a Basic Service Set (BSS) typically employ limited forms of coordination as related to providing the various network functionalities. As a result, there can be interference from a neighboring AP which can diminish the network quality. In order to minimize the various performance issues that may be encountered in multi-AP configurations, multi-AP coordination has been under consideration in the IEEE 802.11 Ultra High Reliability (UHR) Study Group which has been converted to the task group, IEEE 802.11 TGbn.

A STA device can co-exist with a BSS that is not directly connected to the STA device's own AP and can experience interference from this BSS. For example, the AP may (or may not) be within the operational domain/range of one or more of the BSSs that the AP's associated device is facing an interference from. Examples of BSS interference can include a home network deployment in adjacent apartment units, co-existence between two networks managed by different entities such as an infrastructure network and a Mobile AP network, among others. To reduce interference and thus enhance performance, devices in such scenarios may need to coordinate with other devices that are not in the same network and/or operational domain. For example, a Mobile AP may need to coordinate with an infrastructure network with which it co-exists, or a P2P network may need to coordinate with an infrastructure network, among other scenarios. Accordingly, some embodiments provide a framework whereby a device can communicate with an interfering BSS in order to reduce interference, enhance coordination, share time and frequency resources, among other objectives.

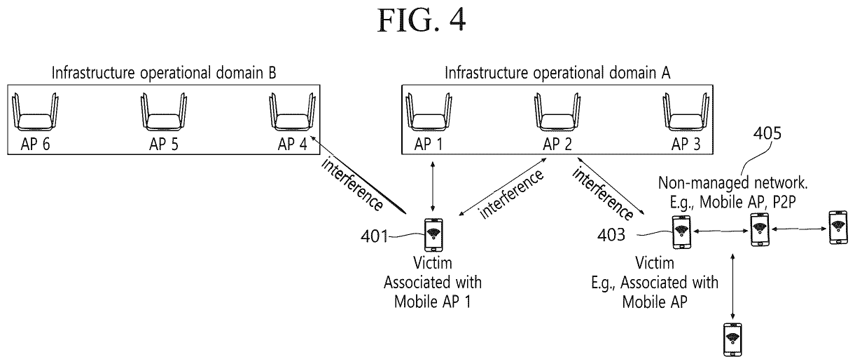

FIG. 4 illustrates an example multi-AP configuration in accordance with an embodiment. For the purpose of efficient management, the infrastructure network can be partitioned into several operational domains. In particular, FIG. 4 illustrates a network that includes two infrastructure operational domains, including infrastructure operational domain B and infrastructure operational domain A. Each infrastructure operational domain can include several APs. In particular, infrastructure operational domain B includes AP6, AP5, and AP4, and infrastructure operational domain A includes AP1, AP2, and AP3. Furthermore, there may be several devices, including device 401 that is associated with AP1. There may be other devices that are part of a non-managed network 405 (e.g., a mobile AP network, P2P network, among others), including device 403 that communicates with several other devices of a non-managed network 405. The infrastructure network can include managed APs that are deployed by a provider/network manager.

Each domain can have a central controlling entity (not illustrated). Devices that are associated with one operational domain AP can face interference from a device (such as AP, STA) in another operational domain. Accordingly, many embodiments provide a framework by which such devices can request and receive assistance from the interfering BSSs.

As illustrated in FIG. 4, there can be a co-existing non-managed network 405, which may be a mobile AP network, a P2P network, among other types of networks. Such networks, being non-managed, may not be a part of the infrastructure operational domains. Such networks can also suffer from interference from the infrastructure network. Similarly, the infrastructure network can also face interference from the operation of non-managed networks. As illustrated, there is a device 401 associated with AP1 that experiences interference from AP4 and AP2. Also, there is a device 403 associated with the non-managed network 405 that experiences interference from AP2.

For efficient operation of multi-AP deployments in next generation wireless networks, many embodiments may provide a framework by which such non-managed networks can request, receive and/or provide assistance from and to the infrastructure network. This can benefit both the infrastructure network as well as the non-managed network.

The embodiments described in detail in this disclosure include assistance link set up procedures, relay set up procedures and operations, frameworks for communication between requestor and assistor, path tracking procedures, and framework based operations for information exchange, among other techniques for coordination.

In some embodiments, a requester may be defined as the entity that is making a request for a particular reason. For example, requesting assistance/coordination for interference reduction, making request for assistance/coordination for resources such as time and/or frequency resources, among other requests. An assistor may be defined as the entity that the request is being made from and that can provide assistance and/or coordination for resources such as time and/or frequency among others.

Some embodiments can provide an assistance link set up. In particular, in some embodiments, when the requestor and the assistor are directly within communication range of each other, they can set up an assistance link for multi-AP coordination purposes. The purpose of this link can be to transmit and receive frames carrying information necessary for multi-AP coordination.

In some embodiments, when a requestor wants to set up an assistance link with an assistor, it can transmit a request frame to the assistor. The request frame can include at least one or more of the information items as described in Table 1.

TABLE 1

| Information item | Description |
|---|---|
| Requestor | Information items that characterize the requestor. e.g., the requestor's |
| information | MAC address. |
| Requestor | Information items that describe the device(s) that the requestor is |
| connection | connected to. e.g., if the requestor is associated with an AP, then it |
| information | can provide the AP information. If the requestor is the AP, then it can |
| | provide information that it is the AP. |
| Requestor network | Information items that describe the requestor's network. e.g., if the |
| information | requestor is a part of a managed network or non-managed network. |
| Requestor's | Information items that describe and provide relevant parameters to set |
| security protocol | up security protocols for communication between the requestor and |
| | the responder. e.g., if the requester is following a particular type of |
| | security protocol that requires some parameters such as security keys |
| | to be known beforehand, then any set up information relevant to the |
| | operation of such security protocols can be included. |
| Setup duration | The duration for which the assistance link needs to be set up. e.g., a |
| | duration value in terms of a particular unit (e.g., ms) can be provided. |
| Dialogue token | A dialogue token that can serve as a reference for this request. The |
| | assistor can provide the same dialogue token in its response |
| Reason code | The reason for setting up the request. e.g., for interference mitigation, |
| | for time and/or frequency resource coordination. There can be a value |
| | for each reason and the value can be indicated. |
| Assistor identifier | An information item that describes the identifier for the device who is |
| | being requested for becoming an assistor. e.g., MAC address of the |
| | device. |
| Timing information | An information item that can enable the requestor and responder to |
| | synchronize their clocks. |
| Assistance link info | An information item that can describe the link to be used as |
| | assistance. e.g., link ID, channel, bandwidth. |

The above information can be carried in a single frame and/or in multiple frames and can be carried in independent frames or in any of the existing frames in the standard.

Upon receiving a request from the requestor, the device that the requestor is making the request to (e.g., the assistor) can provide a response. The response frame can include at least one or more of the information items that are described in Table 2.

TABLE 2

| Information item | Description |
|---|---|
| Assistor | An information item that describes the identifier of the responding |
| information | device. e.g., MAC address |
| Response | An information item that describes the response from the responding |
| information | device. e.g., this can be a reason code. |
| Requestor | An information item that describes an identifier that is provided by the |
| identifier | assistor to the requestor. e.g., upon agreeing to become an assistor, the |
| | assistor can provide the requestor with an identifier which can be used |
| | as a reference to the requestor in future communications. In the case |
| | where the requestor and the responder are both APs, this can be an AP- |
| | ID. |
| Setup duration | An information item that describes the duration for which the assistor |
| | can continue to provide assistance. Beyond this duration the assistance |
| | link may need to be re-setup unless the duration is refreshed or extended |
| | by the assistor. e.g., a time value in a particular unit (e.g., ms). |
| Dialogue token | The same dialogue token that is used by the requestor in its request |
| | frame. |
| Assistor's | Information items that describe and provide relevant parameters to |
| security protocol | setup security protocols for communication between the requestor and |
| | the assistor. e.g., if the assistor is following a particular type of security |
| | protocol that requires some parameters such as security keys to be |
| | known beforehand, then any setup information relevant to the operation |
| | of such security protocols can be included. |
| Timing | An information item that can enable the requestor and responder to |
| information | synchronize their clocks. |
| Assistance link | An information item that can describe the link to be used as assistance. |
| info | e.g., link ID, channel, bandwidth, etc. |

The above information can be carried in a single frame and/or in multiple frames and can be carried in independent frames and/or in any of the existing frames in the standard.

If the responding device agrees to the requestor's request, then the responding device can become an assistor.

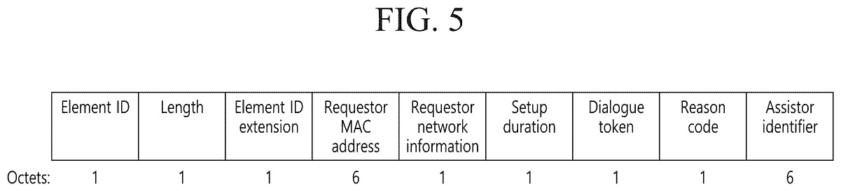

FIG. 5 illustrates a request frame format in accordance with an embodiment. The request frame can include an element ID field, a length field, an element ID extension field, a requestor MAC address field, a requestor network information field, a setup duration field, a dialogue token field, a reason code field, and an assistor identifier field.

The element ID field can provide an identifier for the request frame. The length field may provide a length of the element. The element ID extension field may provide an element ID extension field for the request frame. The requestor MAC address field may provide a MAC address for the requestor. The requestor network information field can be a numerical value that can indicate the type of network which the requestor belongs to. For example, it can take a value of 1 to indicate it is an infrastructure network, a value of 2 for Mobile AP network, and a value of 3 for P2P network. The setup duration field can be a numerical value in microseconds that indicates the duration for which the assistance link is being requested. The dialogue token field can be an integer value that can be generated by the requestor and can be used as a reference for future communication. The reason code field can take a value to indicate that this is a request frame. The value can be pre-decided. The assistor identifier field can be the MAC address of the assistor.

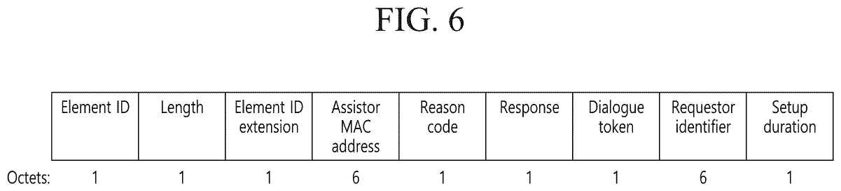

FIG. 6 illustrates a response frame format in accordance with an embodiment. The response format can include an element ID field, a length field, an element ID extension field, a MAC address field, a reason code field, a response field, a dialogue token field, a requestor identifier field, and a setup duration field. The element ID field can provide an identifier for the response frame. The length field may provide a length of the element. The element ID extension field may provide an element ID extension field for the response frame. The assistor MAC address field can be the MAC address of the assistor/responding device. The reason code field can indicate the reason for sending the frame. For example, this can be a numerical value that indicates that this is a response for the request. The response field can take a value of to indicate the response. For example, 1 for accept and 0 for reject. The remaining bits can be reserved. The dialogue token field can be the same as the one in the request format. The requestor identifier field can be an identifier that the assistor provides to the requestor for use in future communication. The setup duration field can be a numerical value in microseconds that indicates the duration for which the assistance link is being set up for.

In some embodiments, if both the requestor and assistor transmit beacon frames that can be received by each other, then the requestor can transmit the request in the beacon frame. The responder can also transmit the response in beacon frames that it transmits.

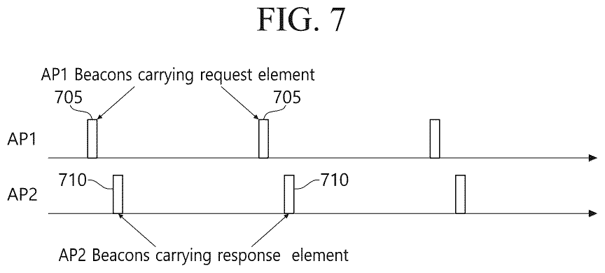

FIG. 7 illustrates an example procedure using a beacon-based request frame and response frame for configuring an assistance link in accordance with an embodiment.

As illustrated, AP1 can transmit a request element in beacon frames 705. This request element can indicate a request for AP2's assistance, which may include setting up an assistance link for MAP coordination. Upon receiving the request, AP2 can process the request. If AP2 is able to provide assistance requested by AP1, AP2 can transmit a response element indicating that AP2 can provide assistance in beacon frames 710. Upon receiving such beacon frames, AP1 becomes aware that it can request for assistance from AP2.

In some embodiments, an explicit request and response frame-based procedure may be utilized.

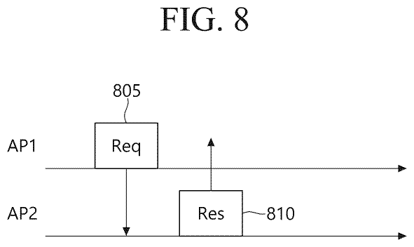

FIG. 8 illustrates a request and response frame-based procedure in accordance with an embodiment.

As illustrated, there can be a request frame 805, requesting assistance from AP2, that can be transmitted by AP1 to AP2. The assistance may include setting up an assistance link for MAP coordination. The request frame may be an action frame that carries a request element. Upon receiving the request frame, AP2 can process the request frame and respond with a response frame 810 indicating whether or not AP2 is capable of providing the assistance requested by AP1. The response frame may be an action frame that carries a response element. Upon receiving the response element with an indication that AP2 will provide assistance (e.g., a positive response), the assistance link between AP1 and AP2 can be set up.

In some embodiment, an AP can advertise a list of assistors that can provide assistance to an AP, for example, through beacon frames. Such an advertisement can enable the recipients of such an advertisement to discover the APs that can serve as assistors. This can be beneficial in several scenarios. For example, before associating with a particular, AP, an STA can verify if one or more of the neighboring APs to the particular AP are assistors or not. Accordingly, the STA can associate with an AP that has assistance links already set up with neighboring APs, which may provide an indication that the AP has better coordination capabilities.

Devices that support a capability to act as an assistor or requestor can advertise their capability in one or more frames, such as beacon frames. Such frames can enable receiving devices to understand that they can request assistance from the AP or that the AP can request assistance from other APs supporting a capability to act as an assistor.

In some embodiments, when the requestor and the assistor do not have a capability to set up an assistance link with each other but their transmissions cause interference to each of their corresponding connected devices, a relay node can be used as an intermediate device that can enable communication between the requestor and the assistor. In some embodiments, one or more relays can be used to enable communication between the requestor and the assistor. For example, in FIG. 4, a device 403 can be associated with a mobile AP 405 and can receive interference from AP2. Accordingly, one or more APs that have assistance links may be set up with AP2. For example, AP3 may set up an assistance link with AP2. As such, AP3 and can act as a relay to enable a coordination between the Mobile AP and the interfering AP.

In some embodiments, when a requestor wants to coordinate with an assistor via a relay device, the requestor can transmit a request frame to the relay device to request that the relay device act as a relay node. The request frame transmitted by the requestor can include one or more of the information items as indicated in Table 3.

TABLE 3

| Information item | Description |
|---|---|
| Requestor | Information items that characterize the requestor. e.g., the requestor's |
| information | MAC address. |
| Requestor network | Information items that describe the requestor's network. e.g., if the |
| information | requestor is a part of a managed network or non-managed network. |
| Requestor's | Information items that describe and provide relevant parameters to |
| security protocol | setup security protocols for communication between the requestor and |
| | the responder. e.g., if the requester is following a particular type of |
| | security protocol that requires some parameters such as security keys |
| | to be known beforehand, then setup information relevant to the |
| | operation of such security protocols can be included. |
| Setup duration | The duration for which the assistance link needs to be setup. e.g., a |
| | duration value in terms of a particular unit (e.g., ms) can be provided. |
| Dialogue token | A dialogue token that can serve as a reference for this request. The |
| | assistor can provide the same dialogue token in its response |
| Reason code | The reason for setting up the request. e.g., for requesting the recipient |
| | to serve as a relay node. There can be a value for each reason and the |
| | value can be indicated. |
| Assistor(s) | An information item that describes the identifier for the device(s) who |
| identifier | is being requested for becoming an assistor. e.g., MAC address of the |
| | device or a list of MAC addresses if there are more than one device. |
| Timing information | An information item that can enable the requestor and responder to |
| | synchronize their clocks. |

The above information can be carried in a single frame and/or in multiple frames and can be carried in independent frames or in any of the existing frames in the standard.

Upon receiving a request from the requestor, the device that the requestor is making the request to may provide a response. The device that the requestor is making a request to, a relay device, can determine if it can enable a communication between the requestor and the assistor (e.g., the device has an assistance link with the intended assistor, the device can setup an assistance link with the intended assistor, or the device can request another device to act as a relay and setup an assistance link through that relay with the intended assistor, among others) and upon determining this, they relay device can transmit a response frame to the requestor. The response frame can include at least one or more of the information items that are described in Table 4.

TABLE 4

| Information item | Description |
|---|---|
| Assistor | An information item that describes the assistor(s) that the relay can |
| information | coordinate with. e.g., this can be a list of MAC addresses of the |
| | assistors. |
| Response | An information item that describes the response from the responding |
| information | device. e.g., this can be a reason code or a list of reason codes |
| | describing the responses. |
| Requestor | An information item that describes an identifier that is provided by the |
| identifier | assistor to the requestor. e.g., there can also be a list of identifiers that |
| | can be provided. |
| Setup duration | An information item that describes the duration for which the assistor |
| | can continue to provide assistance. Beyond this duration the assistance |
| | link may need to be re-setup unless the duration is refreshed or extended |
| | by the assistor. e.g., a time value in a particular unit (e.g., ms), list of |
| | time values if there are more than one assistors. |
| Dialogue token | The same dialogue token that is used by the requestor in its request |
| | frame. |
| Assistor's | Information items that describe and provide relevant parameters to |
| security protocol | setup security protocols for communication between the requestor and |
| | the assistor. e.g., if the assistor is following a particular type of security |
| | protocol that requires some parameters such as security keys to be |
| | known beforehand, then setup information relevant to the operation of |
| | such security protocols can be included. |
| Timing | An information item that can enable the requestor and responder to |
| information | synchronize their clocks. |
| Assistance link | An information item that can describe the link to be used as assistance. |
| info | E.g., link ID, channel, bandwidth, etc. |

The above information can be carried in a single frame and/or in multiple frames and can be carried in independent frames or in any of the existing frames in the standard.

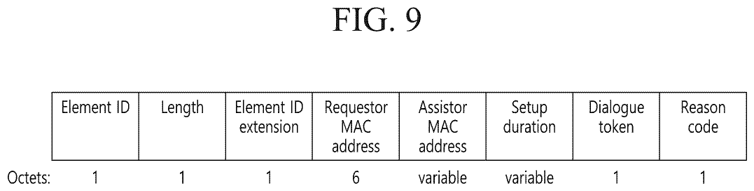

FIG. 9 illustrates a relay request frame format that can be transmitted to request a node to serve as a relay in accordance with an embodiment. The relay request format can include an element ID field, a length field, an element ID extension field, a requestor MAC address field, an assistor MAC address field, a setup duration field, a dialogue token field, and a reason code field.

The element ID field can provide an identifier for the relay request frame. The length field may provide a length of the relay request frame. The element ID extension field may provide an element ID extension field for the relay request frame. The requestor MAC address field can be the MAC address of the requestor. The assistor MAC address field can be a list of MAC addresses of assistors that the requestor is seeking assistance from. The setup duration field can be a list of setup durations with each of the assistors. Dialogue token field can be an integer value that is generated by the requestor. The reason code field can be a value that can indicate the reason for generating the frame. E.g., a request frame to request a device to become a relay.

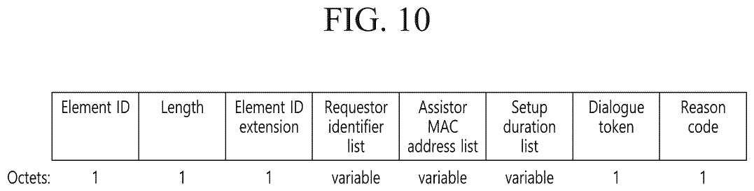

FIG. 10 illustrates a response frame format that can be transmitted to the requestor in accordance with an embodiment. The response frame can include an element ID field, a length field, an element ID extension field, a requestor identifier list field, an assistor MAC address list field, a setup duration list field, a dialogue token field, and a reason code field.

The element ID field can provide an identifier for the response frame. The length field may provide a length of the response frame. The element ID extension field may provide an element ID extension field for the response frame. The requestor identifier list field can be a list of identifiers that have been assigned to the requestor by the assistor(s). The assistor MAC address list field can be the list of devices that agreed to be assistors. The setup duration list field can be a list of durations from each of the assistors for which the assistance can be provided. The dialogue token field can be the same value as the one in the request frame. The reason code field can indicate the reason for sending the frame. For example, a response from the relay regarding the requestor's assistance request.

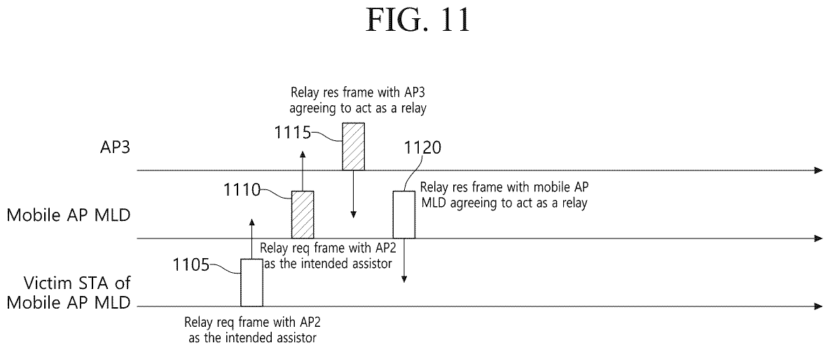

FIG. 11 illustrates a relay setup when an assistance link is already setup in accordance with an embodiment. The embodiment of FIG. 11 is based on the example scenario of FIG. 4. In the embodiments depicted previously in FIG. 4, device 403 associated with mobile AP 405 faces interference from AP2. As illustrated in FIG. 11, victim STA can transmit a request frame 1105 to Mobile AP MLD indicating AP2 as the intended assistor. Mobile AP MLD can then transmit another relay request 1110 to AP3 as the mobile AP MLD knows that AP3 has an assistance link setup with AP2. In some embodiments, mobile AP MLD may receive an advertisement from AP3 regarding the advertisements. If AP3 agrees to act as a relay based on Mobile AP MLD's relay request, AP3 can transmit a relay response 1115 to Mobile AP MLD. Mobile AP MLD can then transmit another relay response 1120 to the victim STA.

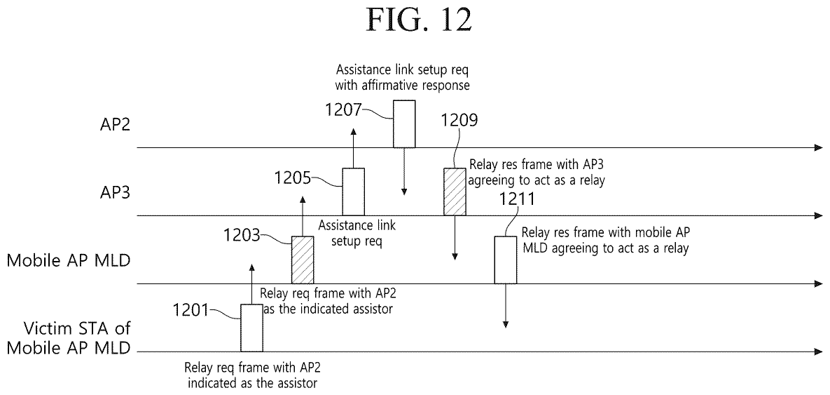

FIG. 12 illustrates a relay setup when an assistance link is not setup in accordance with an embodiment. In particular, FIG. 12 illustrates communication between AP2, AP3, a mobile AP MLD, and a victim STA. A victim STA may be an STA that is experiencing interference from a different network. In FIG. 12, a relay link is not set up between AP3 and AP2. Victim STA can transmit a relay request frame 1201 to Mobile AP MLD. The relay request frame 1201 may indicate AP2 as the intended assistor. Mobile AP MLD can then transmit a relay request frame 1203 to AP3. The relay request frame 1203 may indicate AP2 as the intended assistor. Thus, upon receiving the relay request frame 1203 from the Mobile AP MLD, AP3 can send an assistance link set up request frame 1205 to AP2. Upon receiving a response frame 1207 from AP2 that indicates an affirmative response that AP2 can provide the assistance link, AP3 can then send a relay response frame 1209 to mobile AP MLD agreeing to act as a relay. Upon receiving the relay response frame 1209 from AP3, Mobile AP MLD can transmit a relay response frame 1211 to victim STA. In the relay response frame 1211, Mobile AP MLD may indicate agreeing to serve as a relay to the victim STA.

In some embodiments, when the requester sends the request through the relay to a responder, instead of simply relaying the request to the responder, the relay node can act as a controller in deciding how to relay the information. The guidance can come in different forms.

In some embodiments, the relay node can decide on selecting the best responder node for accommodating the request made by the requester.

In some embodiments, the relay node can decide the mechanism of how to perform the relaying. The relay node can decide the number of relay hops and relaying routes that can best support the request made by the requester.

In some embodiments, there can be multiple relay nodes carrying the request frame.

In some embodiments, the relay node can send the request frame to multiple destination nodes. In some embodiments, more than one responder can assist the requester (for example, in reducing interference towards the requesting node).

In some embodiments, the relay node can be a multi-AP controller, where the other APs are managed or controlled by the multi-AP controller. In some embodiments, the requester can send the request to the controller, and the controller may determine how to best support the request made by the requester.

In some embodiments, the controller relay node may collect requests from different requesting nodes and can accordingly make some decision on how to best accommodate the combined requests received from those multiple nodes. The controller relay node may make some trade-offs in accommodating different requests. In some embodiments, the trade-offs may be decided based on the priority levels of the requester nodes. In certain embodiments, the trade-offs may be decided based on the current deprivation level of the requester nodes. For example, if the controller node deems that a certain requester node has been suffering from OBSS interference for at least a threshold amount of time, the controller node may prioritize assisting that node over others.

In some embodiments, when necessary relay(s) and assistance link(s) have been set up, the requestor and the assistor can communicate with each other for the purpose of multi-AP coordination (e.g., to share time and frequency resources, coordination to reduce interference to each other, among others).

In some embodiments, a container can be defined for carrying information related to MAP coordination related communication between the requestor and the assistor. A container may be referred to as MAP Information Container (MIC) element and can carry information related to multi-AP coordination.

The MIC element can be a collection of one or more elements that are used to express a coordination request and to convey coordination responses to the corresponding requests. The MIC can be a sequence of one or more MAP requests, or a sequence of one or more MAP responses. Each resource request or response can include a MIC data element (MDE) which can be followed by one or more elements that can describe the request and response details.

The MDE can include one or more of the information items as described in Table 5.

TABLE 5

| Information item | Description |
|---|---|
| MDE identifier | An information item that can be used as a reference when referring to a |
| | particular request that is represented by the MDE. e.g., a unique integer |
| | value. |
| Req/resp element | An information item that can be used to describe the number of |
| count | elements carrying request and response that follow the MDE. |
| Requestor | An information item that can be used to describe the requestor |
| identifier | identifier. This requestor identifier can be the identifier that is assigned |
| | to the requestor by the assistor, for instance, based on the set up |
| | procedures described in sec. 1 and sec. 2. |
| Status code | An information item that can describe the result of the request. |

The above information can be carried in a single frame and/or in multiple frames and can be carried in independent frames or in any of the existing frames in the standard.

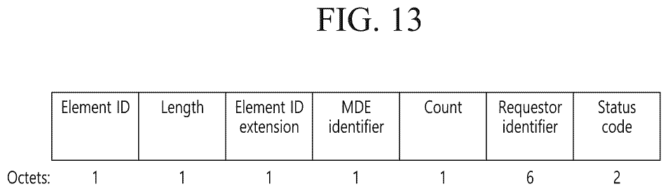

FIG. 13 illustrates a format for MDE in accordance with an embodiment. The MDE can include an element ID field, a length field, an element ID extension field, a MDE identifier field, a count field, a requestor identifier field, and a status code field.

The element ID field can provide an identifier for the MDE. The length field may provide a length of the MDE. The element ID extension field may provide an element ID extension field for the MDE. The MDE identifier field can be a 1 octet value that is generated by the requestor to uniquely identify the MDE within the MIC. The count field can indicate the number of elements that this MDE represents and that follow the MDE. The requestor identifier field can indicate the requestor identifier that is assigned to the requestor by the assistor based on the set up procedures. The status code field can represent the result of the request (when an MDE is for a request frame, this field can be kept reserved and can be used only in MDE that is meant for a response frame).

The MDE can be followed by one or more MIC requests and/or response elements which can be either placed directly and/or can be encapsulated inside a MIC descriptor element. The MIC descriptor element can carry at least one or more of the information items as described in Table 6.

TABLE 6

| Information | |
|---|---|
| item | Descriptor |
| Type | An information item that can be used to describe the |
| information | type of information that is carried inside the MIC |
| | descriptor element. |
| Content | An information item that contains any kind of request |
| information | and response frames/elements. |

The above information can be carried in a single frame and/or in multiple frames and can be carried in independent frames or in any of the existing frames in the standard.

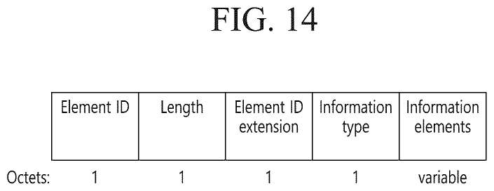

FIG. 14 illustrates a format of a MIC descriptor element in accordance with an embodiment. The response element can include an element ID field, a length field, an element ID extension field, an information type field, and an information elements field.

The element ID field can provide an identifier for the MIC descriptor element. The length field may provide a length of the MIC descriptor element. The element ID extension field may provide an element ID extension field for the MIC descriptor element. The information type field can be a unique predetermined value that can indicate to what type of information is present in the information elements field (e.g., value of 1 to indicate that the information element carries interference measurement reports, among other values). The information elements field can carry additional data that is based on the information type.

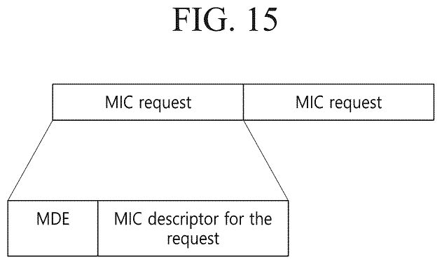

FIG. 15 illustrates a format for MIC of type request in accordance with an embodiment. As illustrated, the frame includes one or more MIC request fields. Each MIC request fields includes MDE field and MIC descriptor for the request field. There can be one or more MIC descriptor for the request fields following each MDE field.

In some embodiments, there can be relay(s) between the requestor and assistor. In order to track who the requests may need to be forwarded to next along the way, there can be a tracking field that can be appended to the MIC. The tracking field can include at least one or more of the information item as described in Table 7.

TABLE 7

| Information | |
|---|---|
| item | Descriptor |
| Assistor | An information item that describes the assistor. e.g., |
| identifier | Assistor MAC address |
| Requestor | An information item that can describe the descriptor. |
| identifier | e.g., Descriptor MAC address |
| Tracker | An information item that can describe the tracking info. |
| information | e.g., a list of MAC addresses of relays along the way in |
| | the same order. |

The above information can be carried in a single frame and/or in multiple frames and can be carried in independent frames or in any of the existing frames in the standard.

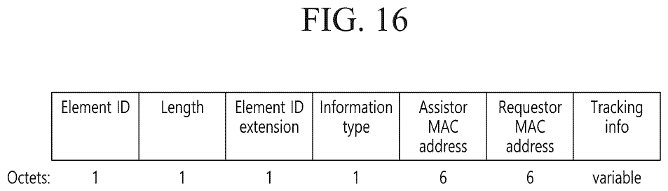

FIG. 16 illustrates a path tracking field in accordance with an embodiment. The path tracking field can include an element ID field, a length field, an element ID extension field, an information type field, an assistor MAC address field, a requestor MAC address field, and a tracking info field.

The element ID field can provide an identifier for the path tracking field. The length field may provide a length of the path tracking field. The element ID extension field may provide an element ID extension field for the path tracking field. The information type may include the type of information in the path tracking field. The assistor MAC address field can be the MAC address of the assistor. The requestor MAC address field can be the MAC address of the requestor. The tracking info field can include one or more MAC addresses of intermediate relay nodes in a particular order (e.g., ordered from requestor to assistor or the other way).

In some embodiments, path tracking may be handled via the IP routing protocol and may not be used inside the MIC framework.

In some embodiments, the requestor that wants to communicate with the assistor can create an MIC (e.g., of type request, response, among others). The MIC can be inserted inside an appropriate message/frame that is transmitted to the relay/assistor. On the path from the requestor to assistor, there can be multiple relays. Each node can place its own MAC address in after the last entry in the tracking info field. This information can be used when sending the response back to the requestor. For example, if there are two relays between the requestor and assistor, when the requestor generates a request, it can insert the MAC address corresponding to the first relay that it communicates with as the first entry in the tracking field. The relay can then insert the next relays MAC address when it receives this frame and prior to forwarding it to the next relay. The next relay can pass the frame to the assistor. When the assistor sends the MIC response frame back, every node can use the tracking information to track the path to the requestor.

When the request received from the requestor is processed, the assistor can create an MIC that includes the responses for each of the requests of the requestor. The MIC can be transmitted back to the requestor.

In some embodiments, aSTA (associated with the Mobile AP MLD) that may be suffering from interference may need to send various types of reports to an assistor for the MAP coordination. The transmitted reports may include an interference report to the assistor to enable the assistor to understand the interference levels faced by the STA and the associated STAs, QoS requirement reports such as QoS characteristic element to enable the assistor understand the QoS requirements of the victim STA, buffer status report (BSR) coupled with delay status reports to enable the assistor to understand the victim STA's traffic urgency and TWT schedule information to enable the assistor to understand the victim STA's SP start time information. The victim STA can create a MIC including the above elements and transmit those to the assistor.

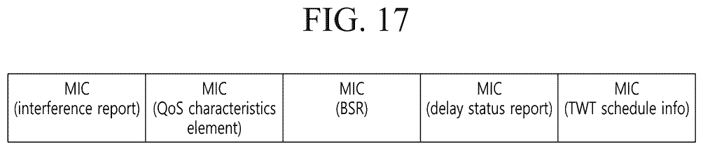

FIG. 17 illustrates a MIC that includes various reports that a requestor may want to provide to an assistor in accordance with an embodiment. The MIC can include a MIC interference report field, a MIC QOS characteristics element field, a MIC BSR field, a MIC delay status report field, and a MIC TWT schedule info field.

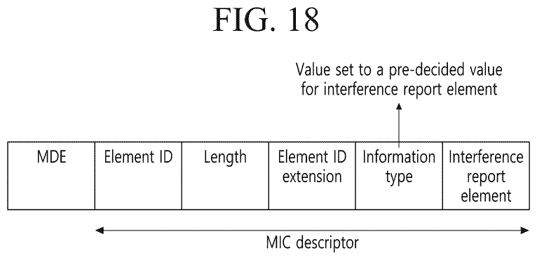

Each of the individual MIC can have a format as shown in FIGS. 18-22

FIG. 18 illustrates a format of the MIC with interference report in accordance with an embodiment. The MIC can include an MDE field, an element ID field, a length field, an element ID extension field, an information type field, and an interference report element field.

The MDE field can include information related to the MIC data element. The element ID field can provide an identifier for the MIC. The length field may provide a length of the MIC. The element ID extension field may provide an element ID extension field for the MIC. The information type may be a value set to a pre-decided value for interference report element. The interference report element field can include an interference report.

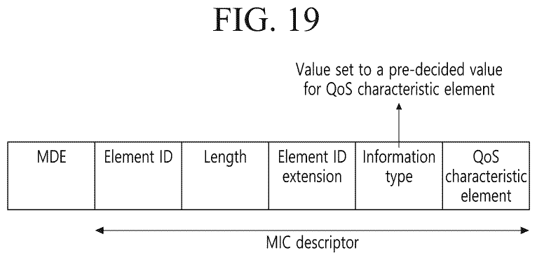

FIG. 19 illustrates a format of MIC with QoS characteristics element in accordance with an embodiment. The MIC with QoS characteristics element can include an MDE field, an element ID field, a length field, an element ID extension field, an information type field, and an QoS characteristic element field.

The MDE field can include information related to the MIC data element. The element ID field can provide an identifier for the MIC. The length field may provide a length of the MIC. The element ID extension field may provide an element ID extension field for the MIC. The information type may be a value set to a pre-decided value for QOS characteristic element. The QoS characteristic element can include QoS characteristics information.

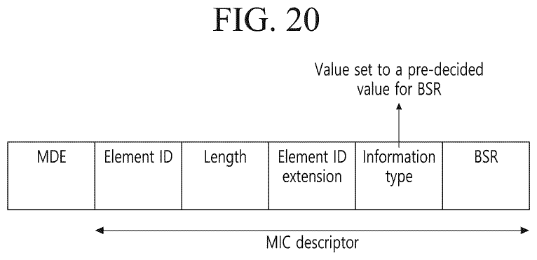

FIG. 20 illustrates a format of MIC with BSR in accordance with an embodiment. The MIC with BSR clement can include an MDE field, an element ID field, a length field, an element ID extension field, an information type field, and BSR field.

The MDE field can include information related to the MIC data element. The element ID field can provide an identifier for the MIC. The length field may provide a length of the MIC. The element ID extension field may provide an element ID extension field for the MIC. The information type may be a value set to a pre-decided value for BSR. The BSR field can include BSR information.

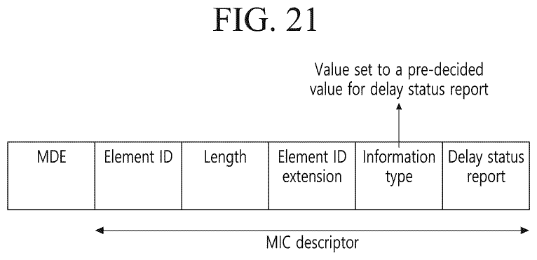

FIG. 21 illustrates a format of MIC with delay status report in accordance with an embodiment. The MIC with delay status report element can include an MDE field, an element ID field, a length field, an element ID extension field, an information type field, and a delay status report field.

The MDE field can include information related to the MIC data element. The element ID field can provide an identifier for the MIC. The length field may provide a length of the MIC. The element ID extension field may provide an element ID extension field for the MIC. The information type may be a value set to a pre-decided value for delay status report. The delay status report field can include delay status information.

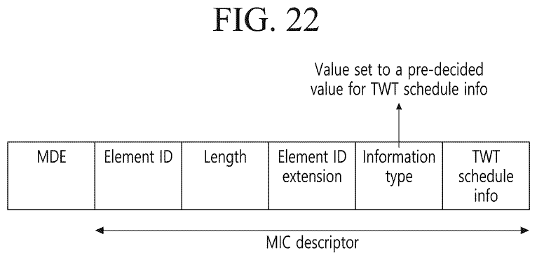

FIG. 22 illustrates a format of MIC with TWT schedule info in accordance with an embodiment. The MIC with TWT schedule info element can include an MDE field, an element ID field, a length field, an element ID extension field, an information type field, and a TWT schedule info field.

The MDE field can include information related to the MIC data element. The element ID field can provide an identifier for the MIC. The length field may provide a length of the MIC. The element ID extension field may provide an element ID extension field for the MIC. The information type may be a value set to a pre-decided value for TWT schedule information. The TWT schedule info field can include TWT schedule information.

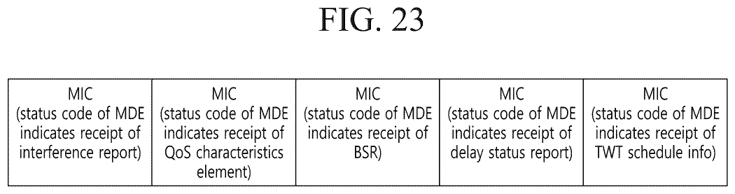

In some embodiments, when the assistor receives the above MICs, it can generate another MIC that includes a response (if needed) for each of these MIC. The response can use the same format. In some embodiments, the response can simply be an acknowledgement from the assistor that it has received these information items from the requestor. The assistor can generate an MIC that can have a format as shown in FIG. 23 in accordance with an embodiment.

FIG. 23 illustrates a format of MIC generated by the assistor in accordance with an embodiment. The MIC can include a status code of MDE indicates receipt of interference report field that indicates receipt of an interference report, status code of MDE indicates receipt of QoS characteristics element field that indicates receipt of a QoS characteristics element, status code of MDE indicates receipt of BSR field that indicates receipt of a BSR, status code of MDE indicates receipt of delay status report field that indicates receipt of a delay status report, and status code of MDE indicates receipt of TWT schedule info field that indicates receipt of a TWT schedule info.

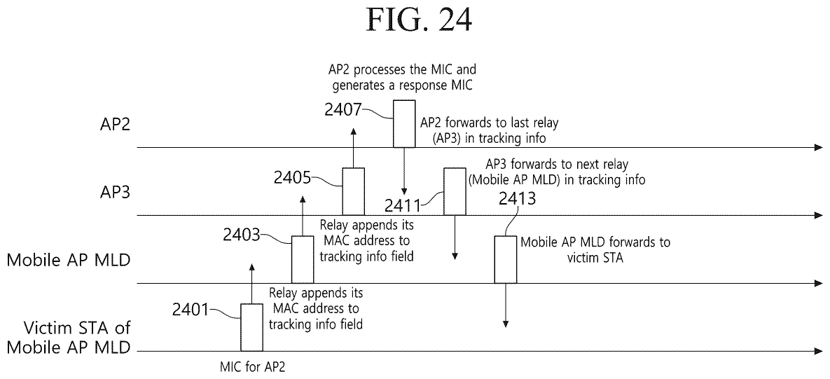

FIG. 24 illustrates a timeline for transmission of MIC with information by requestor and receiving MIC including response from assistor in accordance with an embodiment. In particular, FIG. 24 illustrates communication between AP2, AP3, mobile AP MLD, and victim STA.

Victim STA can transmit a MIC 2401 to mobile AP MLD for AP2. Mobile AP MLD can transmit a relay 2403 to AP3 that appends its MAC address to tracking info field. AP3 can transmit a relay 2405 to AP2 that appends its MAC address to the tracking info field. AP2 can process the MIC and generate a response MIC 2407 that it forwards to last relay (AP3) in the tracking info field. AP3 forwards the MIC response 2411 to next relay (Mobile AP MLD) in the tracking info field. Mobile AP MLD forwards the MIC response 2413 to victim STA.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, the first AP comprising:
a memory;
a processor coupled to the memory, the processor configured to:
transmit a request frame to a second AP to set up an assistance link that is used for multi-AP (MAP) coordination;
receive a response frame from the second AP, wherein the response frame indicates that the second AP agrees to assist the first AP with MAP coordination;
set up the assistance link with the second AP; and
communicate with the second AP via the assistance link for MAP coordination.

2. The first AP of claim 1, wherein the request frame and the response frame are broadcast frames.

3. The first AP of claim 1, wherein the processor is further configured to receive an advertisement from a third AP that advertises a list of assistor APs that are capable of providing coordination for time and frequency resources.

4. The first AP of claim 1, wherein the processor is further configured to transmit a frame advertising a capability to act as an assistor that is capable of providing coordination for time and frequency resources.

5. The first AP of claim 1, wherein the processor is further configured to communicate with a third AP to request that the third AP act as a relay node for communications between the first AP and a fourth AP.

6. The first AP of claim 5, wherein the processor is further configured to:
transmit a request frame to the third AP to request that the third AP acts as the relay node; and
receive a response frame from the third AP to indicate that the third AP agrees to serve as the relay node.

7. The first AP of claim 6, wherein the third AP is a multi-AP controller that manages the first AP, the second AP and the fourth AP.

8. The first AP of claim 1, wherein the processor is further configured to communicate a data element on the assistance link from the first AP to the second AP, wherein the data element includes information related to MAP coordination.

9. The first AP of claim 7, wherein the data element comprises a tracking field that includes address information to track communication amongst the first AP, the second AP and a one or more relay nodes between the first AP and the second AP.

10. The first AP of claim 8, wherein the tracking field includes one or more address information, each address information being associated with a respective one of the one or more relay nodes.

11. A station (STA) in a wireless network, the STA comprising:
a memory;
a processor coupled to the memory, the processor configured to:
transmit a request frame to an access point (AP) to set up an assistance link that is used for multi-AP (MAP) coordination;
receive a response frame from the AP, wherein the response frame indicates that the AP agrees to assist the STA with MAP coordination;
set up the assistance link with the AP; and
communicate with the AP on the assistance link for MAP coordination.

12. The STA of claim 11, wherein the request frame and the response frame are broadcast frames.

13. The STA of claim 11, wherein the processor is further configured to receive an advertisement from another AP that advertises a list of assistor APs that are capable of providing coordination for time and frequency resources.

14. The STA of claim 11, wherein the processor is further configured to transmit a frame advertising a capability to act as an assistor that is capable of providing coordination for time and frequency resources.

15. The STA of claim 11, wherein the AP is a first AP, wherein the processor is further configured to communicate with a second AP to request that the second AP act as a relay node for communications between the STA and a third AP.

16. The STA of claim 15, wherein the processor is further configured to:
transmit a request frame to the second AP to request that the second AP acts as the relay node; and
receive a response frame from the second AP to indicate that the second AP agrees to serve as the relay node.

17. The STA of claim 16, wherein the second AP is a multi-AP controller that manages the first AP and the third AP.

18. The STA of claim 11, wherein the processor is further configured to communicate a data element on the assistance link from the STA to the AP, wherein the data element includes information related to MAP coordination.

19. The STA of claim 17, wherein the data element comprises a tracking field that includes address information to track communication amongst the STA, the AP and one or more relay nodes between the STA and the AP.

20. The STA of claim 18. wherein the tracking field includes one or more address information, each address information being associated with a respective one of the one or more relay nodes.
